(19) United States
(12) Patent Application Publication
(10) Pub. No.: US 2025/0322345 A1
(43) Pub. Date: Oct. 16, 2025

(54) HOST ACTION RANKING ENGINE FOR IMPROVED LISTINGS

(71) Applicant: Airbnb, Inc., San Francisco, CA (US)

(72) Inventors: Sarah Vollmer van Vliet, San Francisco, CA (US); Carlos Adolfo Sanchez Martinez, San Francisco, CA (US); Yunshan Zhu, Sammamish, WA (US); Jenny Chen, La Jolla, CA (US)

(21) Appl. No.: 19/174,545

(22) Filed: Apr. 9, 2025

Related U.S. Application Data
(60) Provisional application No. 63/632,320, filed on Apr. 10, 2024.

(51) Int. Cl. G06Q 10/0639; G06Q 30/0202; G06Q 50/14

(52) U.S. Cl. CPC G06Q 10/06393; G06Q 30/0202; G06Q 50/14

(57) ABSTRACT

Systems and methods are provided. In one example, a method includes retrieving a plurality of host actions associated with a plurality of listings of a listing network platform. The method additionally includes deriving an importance score for one or more host actions of the plurality of host actions, wherein the importance score is based on a forecasted impact of the one or more host actions on a listing. The method further includes estimating a conversion probability for each of the one or more host actions, wherein the conversion probability represents a likelihood that a host of the listing network platform will implement a respective host action. The method also includes aggregating the importance score and the conversion to generate a final host action ranking score, and providing the one or more host actions as a recommendation based on the final host action ranking score.

### PRIORITY

This application claims the benefit of priority to U.S. Provisional Patent Application Ser. No. 63/632,320, filed Apr. 10, 2024, which is incorporated by reference herein in its entirety.

### TECHNICAL FIELD

Embodiments herein generally relate to practical applications in the fields of online booking platforms, specifically systems and methods for improving listings within the hospitality and accommodation industry via a host action ranking engine.

### BACKGROUND

Online booking systems include data analysis and data manipulation systems that are used to review, for example, booking data to make informed decisions before listing a dwelling for booking. Improved automated data analysis of certain data, such as listing data, improves overall performance and the reach of such online booking systems.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some non-limiting examples are illustrated in the figures of the accompanying drawings in which:

FIG. 1 is a diagrammatic representation of a networked environment in which the present disclosure may be deployed, according to some examples.

FIG. 2 illustrates a host action ranking engine (HARE) system, according to some examples.

FIG. 3 is a flowchart of process suitable for recommending one or more actions, according to some examples.

FIG. 4 illustrates side-by-side graphical user interfaces (GUIs) of an action and corresponding YAML file, according to some examples.

FIG. 5 is a screenshot illustrating a dashboard, according to some examples.

FIG. 6 is a screenshot illustrating an interactive dashboard, according to some examples.

FIG. 7 illustrates side-by-side screenshots of communications for recommendations sent to a list host, according to some examples.

FIG. 8 is a diagrammatic representation of a machine in the form of a computer system within which a set of instructions may be executed to cause the machine to perform any one or more of the methodologies discussed herein, according to some examples.

FIG. 9 is a block diagram showing a software architecture within which examples may be implemented.

### DETAILED DESCRIPTION

The following paragraphs describe systems and methods for deriving listing actions to improve booking engagement and customer experience in a listing network platform.

The techniques described herein provide personalized and prioritized recommendations to hosts on online listing platforms, particularly within the hospitality and accommodation industry, including short term bookings. In certain examples, a host action ranking engine (HARE) system provides a centralized, single source of truth system that derives personalized and prioritized guidance to hosts based on their individual listings. The HARE system aggregates data from multiple sources within a listing platform, applies certain algorithms to predict the impact of potential actions on key performance indicators, and uses a unified framework to rank these actions in order of estimated effectiveness. The system takes into account the eligibility of listings for certain actions, strategic guardrails or filters set by the listing platform and/or host, and the probability of action adoption by hosts.

An action refers to a specific recommendation or step that a host on the listing platform can take to improve their listing's performance. Some example actions include price adjustments, amenity additions, such as adding a hot tub, quality improvements, such as upgrading the cleanliness of the booking, availability updates such as, unblocking certain dates, and marketing enhancements, such as improved listing photos. These actions are designed to enhance various aspects of a host's online offerings, such as increasing bookings, increasing revenue, and/or improving guest satisfaction via a practical application that uses certain data science techniques to automatically derive recommendations or actions based on past listing data

Accordingly, the HARE system provides for:

Central Repository: The HARE system serves as a single source of truth, consolidating anonymized data and findings into one centralized system. This allows for the provision of personalized and prioritized guidance to hosts based on their individual listings.

Eligibility and Guardrails: The HARE system assesses whether hosts are eligible for specific actions and applies strategic guardrails (e.g., filters). This ensures that hosts are not advised to take actions that are not suitable for them due to various factors, such as various regulations (e.g., zoning regulations). For example, adding a hot tub will result in more bookings but is not permitted in some locations due to homeowner association regulations.

Impact Estimation: The HARE system estimates, via several models, the potential impact of various actions on key metrics such as gross booking value (GBV), number of nights booked, and quality ratings.

Conversion Probability: Utilizing various models, including machine learning models, the HARE system predicts the likelihood that a host will take a recommended action. The model takes into account the listing's characteristics and the host's historical behavior.

Apples-to-Apples Comparison: The HARE system is capable of standardizing outputs from diverse models into a common metric, such as a percentage lift in bookings and/or GBV. This allows for a comparable ranking of actions despite the different methodologies and output metrics used by the underlying models.

Application Programming Interface (API) and Platform Integration: The HARE system provides one or more APIs that allows for access to HARE system and subsystems, as well as for access to various HARE-provided functionalities, both within an app and externally. These APIs can be used by internal teams as well as third-party systems, making the HARE system a more versatile tool supporting various applications.

The HARE system is used both by hosts as well as other entities, such as sales agents of the listing platform, to derive actions that have a high likelihood of improving various listing metrics, including increased revenue and guest satisfaction. Accordingly, the HARE system leverages data science to provide actionable, personalized, and strategic recommendations to listing platform hosts and other entities, with derived outputs that improve their performance and success on the listing platform.

### Networked Computing Environment

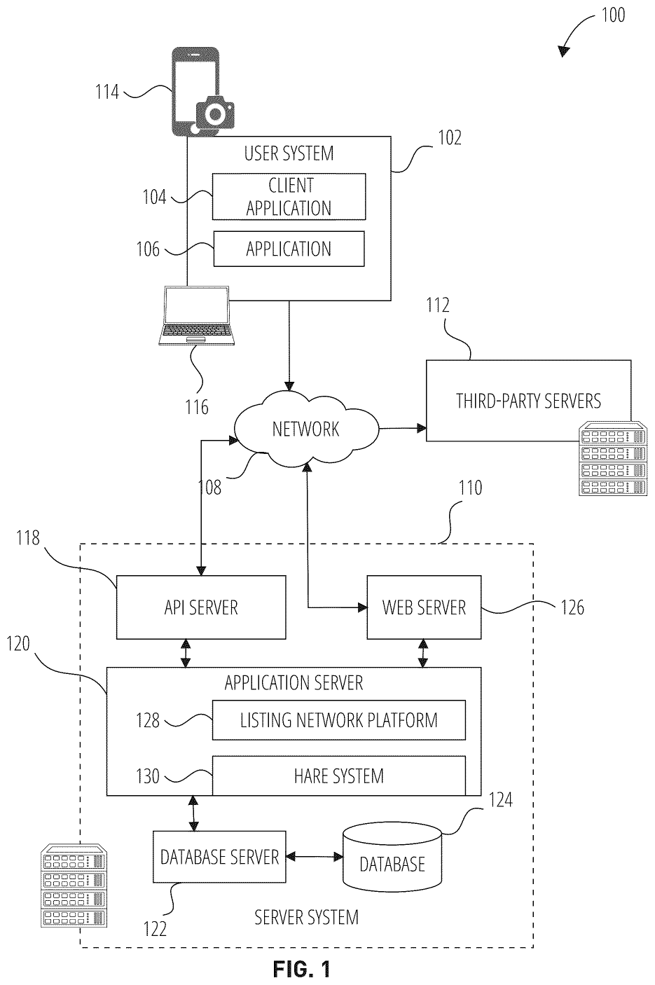

FIG. 1 is a block diagram showing an example networked system 100 for facilitating listing platform services (e.g., publishing goods or services for sale or barter, purchases of goods or services) over a network, in accordance with some examples. The networked system 100 includes multiple user systems 102, each of which hosts multiple applications, including a client application 104 and other applications 106. Each client application 104 is communicatively coupled, via one or more communication networks including a network 108 (e.g., the Internet), to other instances of the client application 104 (e.g., hosted on respective other user systems 102), a server system 110 and third-party servers 112). A client application 104 can also communicate with locally hosted applications 106 using Applications Program Interfaces (APIs).

Each user system 102 may include multiple user devices, such as a mobile device 114 and a computer client device 116 that are communicatively connected to exchange data and messages.

A client application 104 interacts with other client applications 104 and with the server system 110 via the network 108. The data exchanged between the client applications 104 and between the client applications 10 4 and the server system 110 includes functions (e.g., commands to invoke functions) and payload data (e.g., text, audio, video, or other multimedia data).

In some example embodiments, the client application 104 is a reservation application for temporary stays or experiences at hotels, motels, or residences managed by other end users (e.g., a posting end user who owns a home and books out the entire home or private room). In some implementations, the client application(s) client application 104 include various components operable to present information to the user and communicate with the networked system 102. In some embodiments, if the reservation application is included in the client device 110, then this application is configured to locally provide the user interface and at least some of the functionalities with the application configured to communicate with the networked system 102, on an as-needed basis, for data or processing capabilities not locally available (e.g., access to a database of items available for sale, to authenticate a user, to verify a method of payment). Conversely, if the reservation application is not included in the client device 110, the client device 110 can use its web browser to access the e-commerce site (or a variant thereof) hosted on the networked system 102.

The server system 110 provides server-side functionality via the network 108 to the client applications 104. While certain functions of the networked system 100 are described herein as being performed by either a client application 104 or by the server system 110, the location of certain functionality either within the client application 104 or the server system 110 may be a design choice. For example, it may be technically preferable to initially deploy particular technology and functionality within the server system 110 but to later migrate this technology and functionality to the client application 104 where a user system 102 has sufficient processing capacity.

The server system 110 supports various services and operations that are provided to the client application 104. Such operations include transmitting data to, receiving data from, and processing data generated by the client applications 104. This data may include message content, client device information, geolocation information, reservation information, transaction information, message content. Data exchanges within the networked system 100 are invoked and controlled through functions available via user interfaces (UIs) of the client application 104.

Turning now specifically to the server system 110, an Application Program Interface (API) server 118 is coupled to and provides programmatic interfaces to application server 120, making the functions of the application server 120 accessible to the client application 104, other applications 106 and third-party server 112. The application server 120 are communicatively coupled to a database server 122, facilitating access to a database 124 that stores data associated with interactions processed by the application server 120. Similarly, a web server 126 is coupled to the application server 120 and provides web-based interfaces to the application server 120. To this end, the web server 126 processes incoming network requests over the Hypertext Transfer Protocol (HTTP) and several other related protocols.

The Application Program Interface (API) server 118 receives and transmits interaction data (e.g., commands and message payloads) between the application server 120 and the user systems 102 (and, for example, interaction clients 104 and other application 106) and the third-party server 112. Specifically, the Application Program Interface (API) server 118 provides a set of interfaces (e.g., routines and protocols) that can be called or queried by the client application 104 and other applications 106 to invoke functionality of the application server 120. The Application Program Interface (API) server 118 exposes various functions supported by the application server 120, including account registration and login functionality.

The application server 120 host the listing network platform 128 and a HARE system 130 each of which comprises one or more modules or applications and each of which can be embodied as hardware, software, firmware, or any combination thereof. The application server 120 is shown to be coupled to a database server 122 that facilitates access to one or more information storage repositories or database(s) 124.

The listing network platform 128 provides a number of publication functions and listing services to the users who access the networked system 100. While the listing network platform 128 is shown in FIG. 1 to form part of the networked system 100, it will be appreciated that, in alternative embodiments, the listing network platform 128 may form part of a web service that is separate and distinct from the networked system 100. The listing network platform 128 can be hosted on dedicated or shared server machines that are communicatively coupled to enable communications between server machines. The listing network platform 128 provides a number of publishing and listing mechanisms whereby a seller (also referred to as a “first user,” posting user, host) may list (or publish information concerning) goods or services for sale or barter, a buyer (also referred to as a “second user,” searching user, guest) can express interest in or indicate a desire to purchase or barter such goods or services, and a transaction (such as a trade) may be completed pertaining to the goods or services.

The HARE system 130 uses various data science modeling techniques further described below to more efficiently process large volumes of data captured by the listing network platform 128. For example, listing data is anonymized and then analyzed to derive and to categorize certain listing actions that can improve listing performance. The listing actions include price adjustments, amenity additions, such as adding a hot tub, quality improvements, such as upgrading the cleanliness of the booking, availability updates such as, unblocking certain dates, and marketing enhancements, such as improved listing photos. In certain examples, the HARE system 130 first determines eligibility that a listing can get a recommendation for an action. For example, certain actions may not be eligible for recommendation if a listing does not have instant booking, where a guest can instantly book the listing without host interaction. Guardrailing is also provided via the HARE system 130, where certain filters are applied before suggesting an eligible action. For example, a listing can benefit from adding instant booking but guardrailing derives that this action should not be recommended based on a high number of cancelations by the host. Accordingly, guardrailing applies the listing's host behavior, regulations found for the listing, and the like, using a set of guardrailing rules. The guardrailing rules include “if . . . then” rules such as “if hoa_regulations=no_hot_tubs then remove_from_recommended_action (add_hot_tub).” Actions that are eligible and pass guardrailing then undergo an impact analysis using various models. The impact analysis estimates the impact of the action on the listing by deriving certain metrics, such as gross booking value (GBV), quality metrics, nights booked, and/or effects in search rankings, as further described below. The HARE system 130 additionally estimates the chances of the host converting or otherwise implementing the suggested action by deriving probability of conversion. By providing for a comprehensive data science-based analysis of actions that a listing can take, the HARE system 130 can more efficiently provide a customized ranking of actionable items suitable for improving a host's listing results.

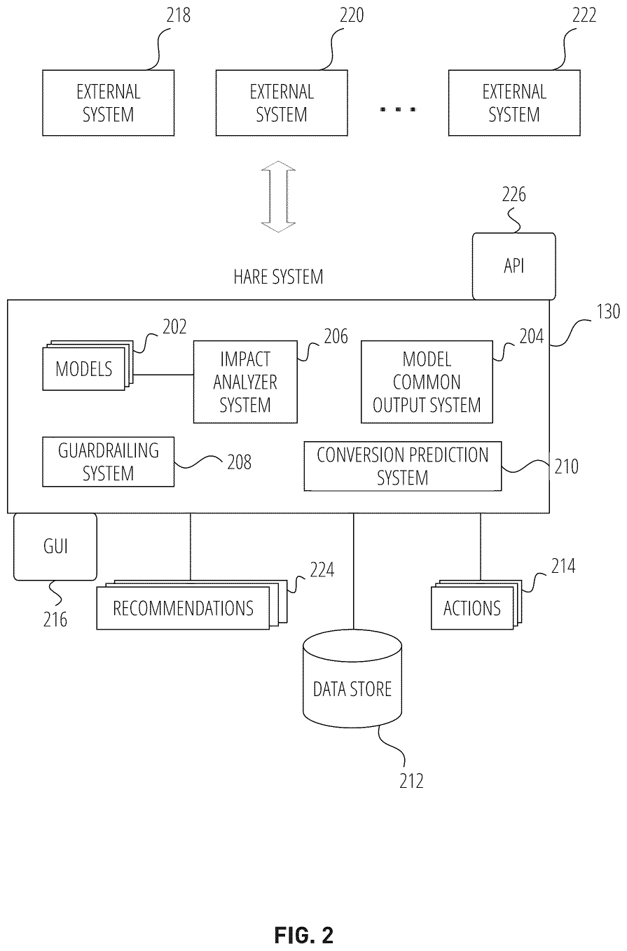

FIG. 2 is a block diagram illustrating the host action ranking engine system (HARE) 130, according to some examples. In the depicted example, the HARE system 130 includes one or more impact assessment models 202, a model common output system 204, an impact analyzer system 206, a guardrailing system 208, and a conversion prediction system 210. Also shown is a data store 212 operatively coupled to the HARE system 130. During operations, the HARE system 130 accesses the data store 212 to retrieve anonymized listing data, such as pricing data, quality data (e.g., number of stars given to listings), guest feedback and reviews, marketing material used for each listing, geographic location of listings, regulatory information (e.g., HOA rules, zoning regulations), previous GBV for each listing, nights booked (e.g., bookings per week, per month, per year), and so on.

The HARE system 130 additionally has access to a list of actions 214. In some examples, an action 214 is encapsulated in a file, such as a data serialization language file. In one example, YAML is Not A Markup Language (YAML) files are used to store the actions 214. The actions 214, in some examples, are stored via the data store 212. The actions 214 include a lever or a category that the action belongs to. Some example levers are merchandising, pricing, marketing, revenue, GBV, and so on. The lever or category can be used to generate recommendations based on merchandising actions, pricing actions, marketing actions, revenue increasing actions, and/or GBV improvement actions. The HARE system 130 will then generate one or more recommendations by analyzing the data store 212 to find similar anonymized listings that showed improved performance, such as improved merchandising, pricing, marketing, revenue, GBV, and so on.

The guardrailing system 208 prevents the recommendation of actions 214 that could lead to negative outcomes for hosts or guests. For example, if a host has a history of cancellations, the system might guardrail against recommending settings that could lead to overbooking. The guardrailing system 208 additionally customizes recommendations to the specific circumstances of each host. For instance, if a host's listing is not already fully booked for particular set of dates, the system would not recommend actions aimed at increasing bookings during that period. The guardrailing system 208 also helps ensure that recommendations comply with local laws or regulations. For example, if a city has a restriction on the number of days a property can be booked out, the system would guardrail against recommending actions that could exceed those limits. Likewise, the guardrailing system 208 aids in maintaining a certain standard of quality and experience. If a listing does not meet certain quality thresholds, the system might guardrail against recommending it for premium placement or special promotions. In some examples, the guardrailing system 208 helps the listing network platform 128 maintain certain consistency and quality in the listings by promoting certain behaviors or discouraging others.

The impact analyzer system 206 uses the models 202 to measure various impact or importance metrics for each of the actions 214. For each action, the impact analyzer system 206 uses an “importance” measure. Importance is based on different objectives, such as monetary outcomes (e.g., increased bookings or GBV) or non-monetary outcomes (e.g., improved quality of stay). That is, some models 202 derive monetary outcomes and monetary metrics while other models 202 derive non-monetary outcomes and non-monetary metrics for one of the actions 214. Indeed, each of the models 202 derive one or more metrics, which can be monetary or non-monetary depending on the model. Some example models 202 include an amenities model, which uses named entity recognition (NER) techniques to infer the importance of each amenity from the frequency of guest inquiry and complaints contained within unstructured text (guest comments in reviews, and customer support tickets, and so on).

An Availability Retention Reactivations (AARR) model 202 uses matching production that model how multiple inputs (e.g. supply and demand) match and produce a certain output (e.g. nights). Examples of the matching functions include: Cobb-Douglas, constant elasticity of substitution, and so on. The AAR model is trained with historical data, for example, anonymized data captured by the listing network platform 128, and the model is then used to measure the incremental value from adding supply, such as more listings, to the listing network platform 128. A merchandising model 202, such as a future incremental value (FIV) model, uses propensity score matching. Propensity score matching (PSM) is a quasi-experimental method in which statistical techniques are used to construct an artificial control group by matching each treated unit with a non-treated unit of similar characteristics. Using these matches, an estimate the impact of an intervention is then derived. Propensity score matching helps measure the impact from a listing taking an action by comparing listings that took the action against similar listings that didn't take the action, and after accounting for confounding variables.

A pricing model 202 models price elasticity via experimentation techniques. Experimentation provides for a measure of the impact of pricing actions by measuring how changes in prices for a randomized target listing impacts its outcomes compared to randomized control listings that did not change their prices. A quality model 202 uses regularized ridge regression to measure the impact of quality attributes, such as customer support tickets, host ratings, the rate of guest rebooking, and the like. This quality model 202 is used in conjunction with knowledge of direct customer support costs, co-traveler rebooking, word-of-mouth effects, and other factors to measure the impact of actions on quality and commercial outcomes. Availability models 202 are also provided, that use a Cobb Douglass production function or utility function applying economic theory to deriving incremental returns.

In order to provide an apple-to-apples comparison or common results between model 202 outputs, in certain examples, a model common output system 204 is used. The model common output system 204 applies a scalable importance function is used, which supports multiple sources and objectives over a desired time horizon, such as 365 days. In one example, the modeling function, for a given action outcome, action a, listing l, night n, and horizon H (e.g., 365 days), generalizes an importance measure as follows:

$$Δ {v}_{a , l} = {\sum }_{n}^{H} {e}_{n , a , l} \cdot {Lift}_{n , a , l} \cdot Baseline {Outcome}_{n , l} \cdot {C}_{n , a , l}$$

where Δv_{a,l} is an expected increase in importance from taking the action. e_{n,a,l} is a value denoting whether the listing night is eligible to take the action, with additional guardrails to account for strategic factors. Lift_{n,a,l} is a forecast lift from taking the action, which can come from an experiment or a model 202. Lift is an expected increase in a particular outcome as a result of taking a specific action. It is a measure of the effectiveness or impact of an action on a host's listing performance. The term is used to describe the improvement or positive change in a metric attributable to a particular variable or intervention. For example, if an action such as reducing the minimum length of stay (LOS) is predicted to increase bookings by 10%, the lift for this action would be 10%. This lift value would then be used in the HARE system's calculations to rank the action in terms of its importance and potential impact on the host's success. Baseline Outcome_{n,l} is a baseline outcome of interest, such as nights stayed. C_{n,a,l} is a probability that the host will take the action.

After using the scalable importance function, the actions 214 are ranked from highest to lowest value ΔV_{a,l}>Δv_{a,l} and recommend surfacing or otherwise suggesting top recommendations 224. The scalable importance function has multiple benefits. For example, the scalable importance function is an objective function that supports a wide range of objectives. In one example, the GBV impact of an action can be estimated using the scalable importance function as follows:

$$Δ {v}_{a , l} = {\sum }_{n}^{H} {e}_{n , a , l} \cdot GBV {Lift}_{n , a , l} \cdot Baseline {GBV}_{n , l} \cdot {C}_{n , a , l}$$

where GBV Lift_{n,a,k} is a percent Lift in GBV from taking action a, and Baseline GBV_{n,l} is a baseline GBV if the listing takes no action.

The scalable importance function also provides for interpretability. That is, the scores are easy to interpret, and can be aggregated or averaged across listings to estimate rough opportunity sizes across listings, actions, and levers. Furthermore, the scalable importance function provides for flexibility. By modifying the logic for eligibility e_{n,a,l} or Lift_{n,a,l} specific actions can be demoted or boosted based listing network platform 128 strategies, such as strategies to improve listing quality, consistency, and so on.

The conversion prediction system 210 estimates a likelihood that a host will take a recommended action 214 based on the guidance provided to the host. In certain examples, the conversion prediction system 210 includes a conversion probability model, such as a machine learning model, which outputs a probability score indicating how likely the host is to implement the specific action. The conversion prediction system 210 gathers historical data on host behavior from the data store 212, including past actions taken by hosts, characteristics of their listings, interaction data with the platform (such as clicks, views, and dismissals), and any other relevant information that could influence a host's decision to take an action. From the collected data, the conversion prediction system 210 would derive features that are indicative of a host's propensity to take action. These features could include demographic information, listing performance metrics, historical responsiveness, and any previous interactions with similar recommendations. The machine learning model is trained using the engineered features and historical outcomes, such as whether or not the host took the action. The machine learning model could be a classification algorithm, such as logistic regression, decision trees, or a more complex model like a gradient boosting machine or neural network.

Once trained, the machine learning model would use current data to estimate the probability of conversion for each recommended action. The output would be a score between 0 and 1, where 0 indicates no likelihood of conversion and 1 indicates certainty. In some examples, further filtering of actions that have high probability of conversion then results in the recommendations 224. The ranked list of actions, along with their associated conversion probabilities, are then communicated to hosts through a graphical user interface (GUI) 216, emails, or other communication channels. In some examples, the conversion prediction system 210 incorporates a feedback loop where the outcomes of the recommendations 224 (whether or not the host took the action) are fed back into the machine learning model to refine and improve its predictive accuracy over time. The performance of the conversion prediction system 210 is continuously monitored and evaluated against actual host actions to ensure it remains effective and accurate. By incorporating a conversion prediction probability system, the HARE system 130 is able to provide more targeted and effective recommendations, minimizing and focusing the recommendations 224, thus ultimately helping hosts to make better-informed decisions that could lead to improved performance of their listings on the listing network platform 128.

Also depicted are external systems 218, 220, 222. The external systems 218, 220, 222 include other network platforms, software applications, mobile applications, and so on that interface with the HARE system 130 and subsystems via an application programming interface (API) 226. The API 226 includes functions, objects, subroutines, and the like, useful in providing operative access to the models 202, the impact analyzer system 206, the model common output system 204, the guardrailing system 208, and the conversion prediction system 210. Accordingly, the HARE system 130 provides its functionality to any number of external systems, including sales support systems, business process automation systems, and so on.

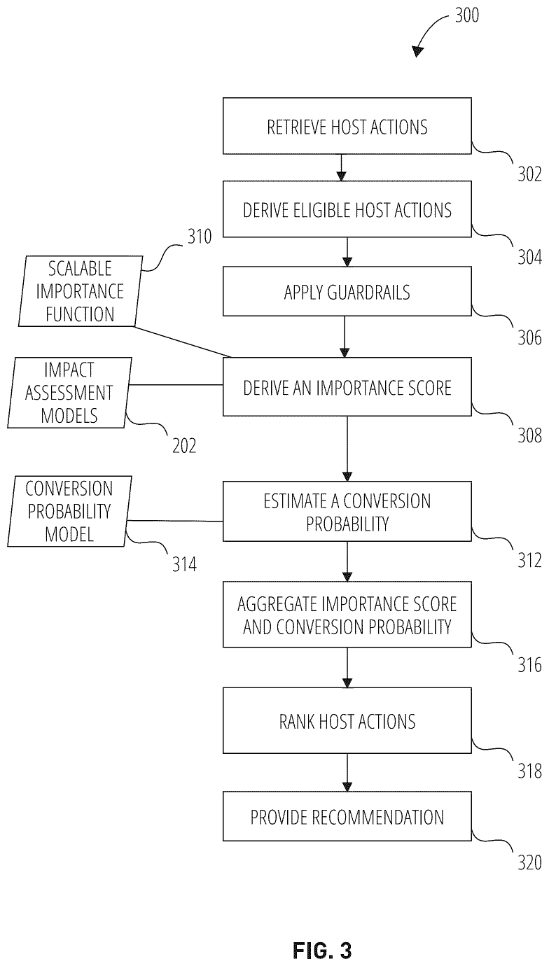

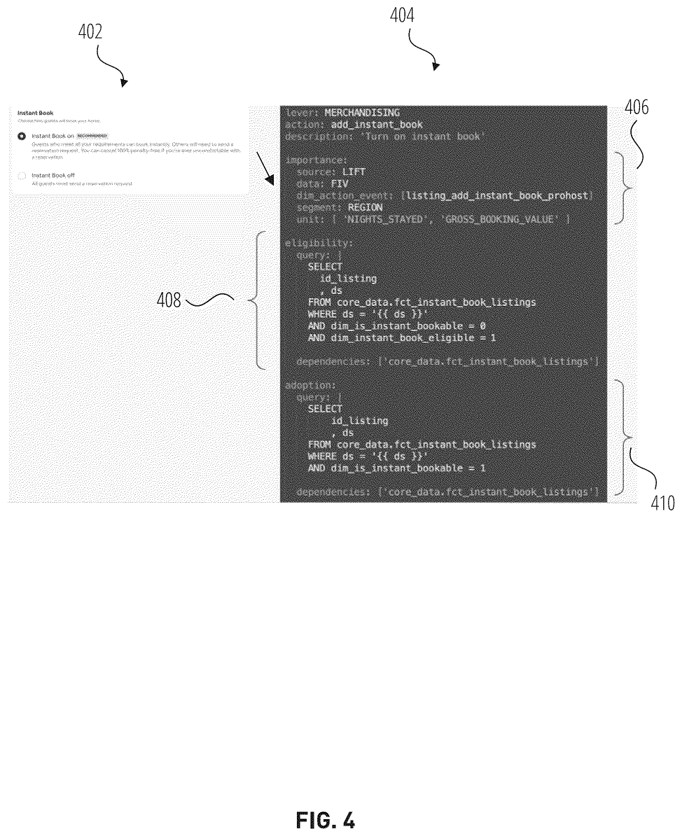

Turning now to FIG. 3 which is a flowchart of a recommendation process 300 suitable for providing one or more recommendations based on host actions, according to some examples. In the depicted example, the process 300 retrieves, at block 302, one or more host actions 214. For example, the process 300 retrieves, via the data store 212, host actions 214 stored in the data store 212. The process 300 then derives, at block 304, retrieved host actions that are also eligible hosts. For example, certain host actions may not be eligible for recommendation if a listing does not have instant booking, where a guest can instantly book the listing without first notifying a host. In some examples, each action carries executable content that is used to determine eligibility. For example, the action, when encapsulated in a YAML file, contains certain code, such as structure query language (SQL) code, that when executed provides for a list of eligible and/or non-eligible listing for the action. Further details of an example YAML file are found in FIG. 4.

The process 300 then, at block 306, applies guardrail rules to further filter the eligible actions. As mentioned earlier, guardrailing prevents the recommendation of eligible actions 214 that could lead to negative outcomes for hosts or guests. For example, if a host has a history of cancellations, the process 300 might guardrail against recommending settings that could lead to overbooking. Guardrailing additionally customizes recommendations to the specific circumstances of each host. For instance, if a host's listing is not already fully booked for particular set of dates, the system would not recommend actions aimed at increasing bookings during that period. Further, guardrailing helps ensure that recommendations comply with local laws or regulations, such as not recommending the addition of certain amenities, such as a hot tub, in locations where HOA and/or zoning regulations do not permit them.

The process 300 then derives, at block 308, an importance score for each of the eligible host actions that have undergone guardrailing. In the depicted example, one or more impact assessment models 202 are used to first derive monetary and non-monetary metrics.

The metrics include GBV, incremental value from adding extra supply of listings, predicted impact of an action in dollars and/or in quality, predicted ratings, predicted search ranking, price elasticity metrics, incremental return, reactivation value, and the like. In some examples, a scalable importance function 310 is then used, such as the previously described

$$Δ {v}_{a , l} = {\sum }_{n}^{H} {e}_{n , a , l} \cdot {Lift}_{n , a , l} \cdot Baseline {Outcome}_{n , l} \cdot {C}_{n , a , l}$$

to generalize each of the monetary and non-monetary metrics. That is, the scalable importance function is able to be generalized to output the same value regardless of the monetary and/or non-monetary metric used as input. Accordingly, Δv_{a,l} is referred to as the importance score.

The process 300 then estimates, at block 312, a conversion probability for each of the eligible and guardrailed host actions. The conversion probability applies a conversion probability model 314 to derive the conversion probability. In some examples, the conversion probability model 314 is a machine learning model that has been trained with historical data on host behavior from the data store 212, including past actions taken by hosts, characteristics of their listings, interaction data with the platform (such as clicks, views, and dismissals), and any other relevant information that could influence a host's decision to take an action. From the collected data, the conversion probability model 314 then derives features that are indicative of a host's propensity to take action. In use, the conversion probability model 314 will then assign a probability value between 0 and 1 of a given host converting or otherwise applying the host action, where 0 indicates no likelihood of conversion and 1 indicates certainty of conversion.

The process 300 then aggregates, at block 316, the importance score with the conversion probability for each of the eligible and guardrailed host actions to arrive at a final host action ranking score. In some embodiments, the aggregation uses weights, so that each contribution can be adjusted by adjusting their respective weights. In one example, the aggregation is a simple multiplication, such as final host action ranking score=importance score×weight_1×probability value×weight_2. The process 300 then ranks, at block 318, the eligible and guardrailed host actions based on their individual total ranking scores. Eligible and guardrailed host actions with larger total ranking scores are ranked higher. The process 300 then, at block 320, provides the ranked list of eligible and guardrailed host actions as recommendations. In some examples, the recommendations only include eligible and guardrailed host actions having a total ranking score over a certain threshold.

Turning now to FIG. 4, the figure depicts side-by-side GUIs 402, 404 of an action and a corresponding YAML file representative of the action, according to some examples. More specifically, the GUI 402 illustrates a host's ability to turn on or off the action of instant booking for guests. The GUI 404 illustrates the YAML file corresponding to the action of instant booking. In the depicted embodiment, the GUI 404 includes a lever name, action name, and description as a file header. Section 406 is used to enter information used in determining which of the models 202 to use to calculate the importance score for the host action, as well as model parameters. Section 408 then includes eligibility criteria in executable form. More specifically, SQL code is included that queries a relational data table for listings that are eligible. Section 410 contains additional SQL code. The YAML file section via the GUI 404 is editable via the GUI 216. Additionally, new actions can be created by simply creating a new YAML file, via the GUI 216 and/or via code that writes a new YAML file.

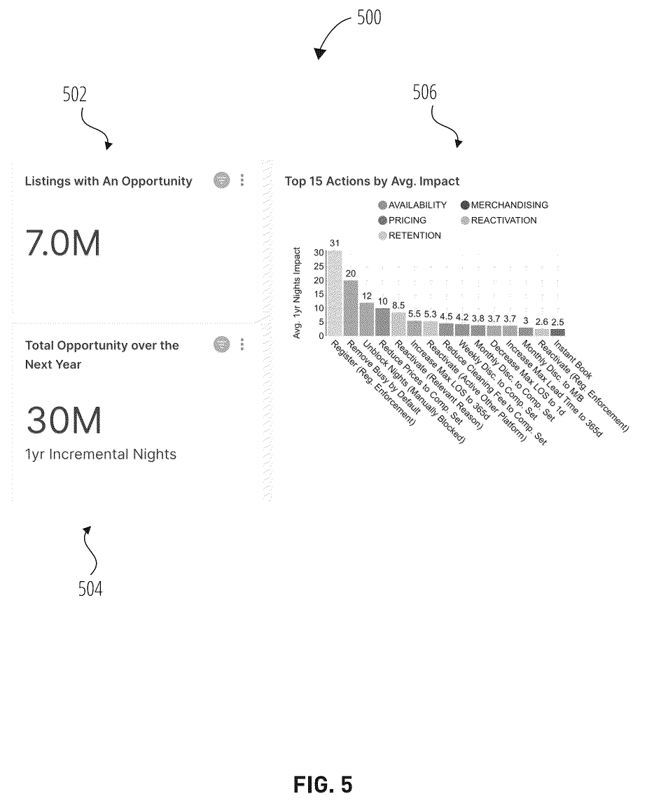

The HARE system 130 also provides for various reports and data presentations, such as an example dashboard 500 shown in FIG. 5. More specifically, FIG. 5 is a screenshot illustrating panels 502, 504, and 506, of the dashboard 500, according to some examples. The dashboard 500 is displayed via the GUI 216. In the depicted embodiment, panel 502 displays an estimated monetary amount for opportunities, such as raising revenue based on 1 year incremental nights, currently available based on actions that are not yet converted or otherwise implemented. Panel 504 is used to display a total monetary amount for opportunities over a future year based on actions that are not yet converted or otherwise implemented. The dashboard 500 also includes a panel 506, which is used to display a bar chart of actions that have not yet been converted. In the example, the bar chart ranks the actions by average 1 year nights impact amount, with each bar of the bar chart colored to represent the lever or category that each action belongs to. It is to be understood that other visualizations can be presented, including pie charts, line graphs, radar graphs, and the like, as well as visualizations for other opportunities.

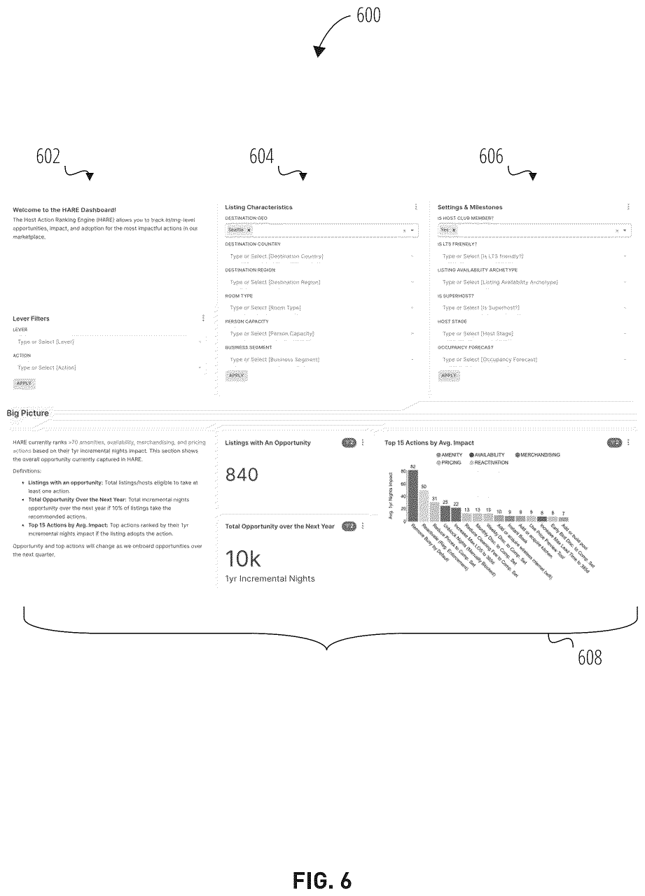

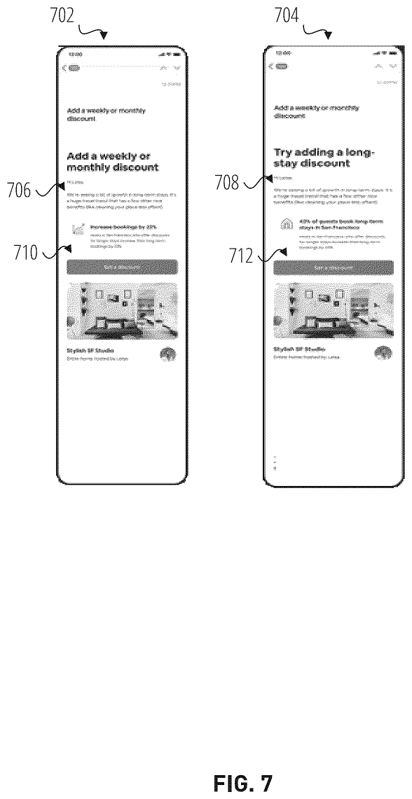

FIG. 6 is a screenshot of an interactive dashboard 600, according to some examples. In the depicted example, a panel 602 includes GUI controls for selecting levers and actions. Likewise, a panel 604 is provided, that includes GUI controls for selecting listing characteristics, such as geographic region, room type, and the like, to retrieve information for one or more listings of interest. A panel 606 is additionally provided, that includes GUI controls for selecting settings and milestones to further filter hosts by certain host characteristics. A section 608 then will present information related to opportunities and impact of actions not yet converted, similar to the information presented by the dashboard 500 of FIG. 5. By presenting for interactive dashboard visualizations, the HARE system 130 presents more focuses and actionable information. In certain examples, hosts can be sent recommendations via various communication channels, as shown in FIG. 7.

FIG. 7 shows example screenshots 702, 704 of communications for recommendations sent to a host, according to some examples. The communications can include email, an application screen, application pop-ups, push notifications, and so on. In the depicted example, screenshot 702 is of an email focusing on recommending a discount. A summary of the recommendation is presented in sections 706, 708, respectively, containing an impact analysis of following the recommendation. Additionally, button controls 710, 712 are presented, suitable for initiating the process of following the recommendation. That is, by activating controls 710, 712, the host receiving the recommendation can navigate to an online system, for example, to enable the recommendation, such as enabling instant booking. By providing for actionable communications recommending certain actions, the HARE system 130 more efficiently interacts with hosts to improve listing value and results.

### Machine Architecture

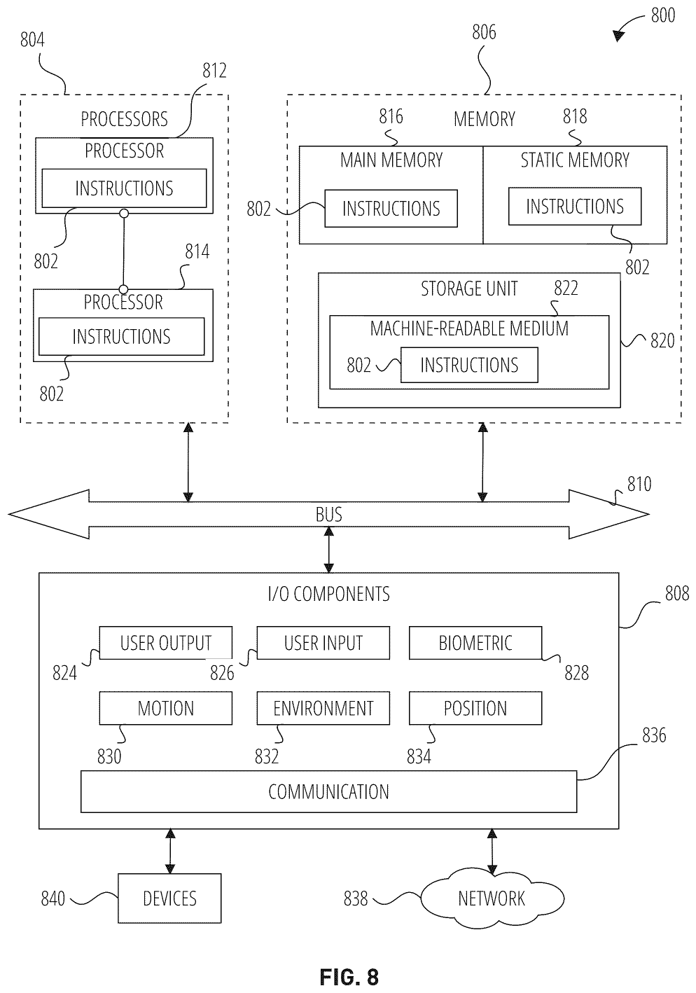

FIG. 8 is a diagrammatic representation of the machine 800 within which instructions 802 (e.g., software, a program, an application, an applet, an app, or other executable code) for causing the machine 800 to perform any one or more of the methodologies discussed herein may be executed. For example, the instructions 802 may cause the machine 800 to execute any one or more of the methods described herein. The instructions 802 transform the general, non-programmed machine 800 into a particular machine 800 programmed to carry out the described and illustrated functions in the manner described. The machine 800 may operate as a standalone device or may be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 802, sequentially or otherwise, that specify actions to be taken by the machine 800. Further, while a single machine 800 is illustrated, the term “machine” shall also be taken to include a collection of machines that individually or jointly execute the instructions 802 to perform any one or more of the methodologies discussed herein. The machine 800, for example, may comprise the user system 102 or any one of multiple server devices forming part of the server system 110. In some examples, the machine 800 may also comprise both client and server systems, with certain operations of a particular method or algorithm being performed on the server-side and with certain operations of the particular method or algorithm being performed on the client-side.

The machine 800 may include processors 804, memory 806, and input/output I/O components 808, which may be configured to communicate with each other via a bus 810. In an example, the processors 804 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 812 and a processor 814 that execute the instructions 802. The term “processor” is intended to include multi-core processors that may comprise two or more independent processors (sometimes referred to as “cores”) that may execute instructions contemporaneously. Although FIG. 8 shows multiple processors 804, the machine 800 may include a single processor with a single-core, a single processor with multiple cores (e.g., a multi-core processor), multiple processors with a single core, multiple processors with multiples cores, or any combination thereof.

The memory 806 includes a main memory 816, a static memory 818, and a storage unit 820, both accessible to the processors 804 via the bus 810. The main memory 806, the static memory 818, and storage unit 820 store the instructions 802 embodying any one or more of the methodologies or functions described herein. The instructions 802 may also reside, completely or partially, within the main memory 816, within the static memory 818, within machine-readable medium 822 within the storage unit 820, within at least one of the processors 804 (e.g., within the processor's cache memory), or any suitable combination thereof, during execution thereof by the machine 800.

The I/O components 808 may include a wide variety of components to receive input, provide output, produce output, transmit information, exchange information, capture measurements, and so on. The specific I/O components 808 that are included in a particular machine will depend on the type of machine. For example, portable machines such as mobile phones may include a touch input device or other such input mechanisms, while a headless server machine will likely not include such a touch input device. It will be appreciated that the I/O components 808 may include many other components that are not shown in FIG. 8. In various examples, the I/O components 808 may include user output components 824 and user input components 826. The user output components 824 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 826 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 808 may include biometric components 828, motion components 830, environmental components 832, or position components 834, among a wide array of other components. For example, the biometric components 828 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The biometric components may include a brain-machine interface (BMI) system that allows communication between the brain and an external device or machine. This may be achieved by recording brain activity data, translating this data into a format that can be understood by a computer, and then using the resulting signals to control the device or machine.

Example types of BMI technologies, including:
Electroencephalography (EEG) based BMIs, which record electrical activity in the brain using electrodes placed on the scalp.
Invasive BMIs, which used electrodes that are surgically implanted into the brain.
Optogenetics BMIs, which use light to control the activity of specific nerve cells in the brain.

Any biometric data collected by the biometric components is captured and stored only with user approval and deleted on user request. Further, such biometric data may be used for very limited purposes, such as identification verification. To ensure limited and authorized use of biometric information and other personally identifiable information (PII), access to this data is restricted to authorized personnel only, if at all. Any use of biometric data may strictly be limited to identification verification purposes, and the data is not shared or sold to any third party without the explicit consent of the user. In addition, appropriate technical and organizational measures are implemented to ensure the security and confidentiality of this sensitive information.

The motion components 830 include acceleration sensor components (e.g., accelerometer), gravitation sensor components, rotation sensor components (e.g., gyroscope).

The environmental components 832 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

With respect to cameras, the user system 102 may have a camera system comprising, for example, front cameras on a front surface of the user system 102 and rear cameras on a rear surface of the user system 102. The front cameras may, for example, be used to capture still images and video of a user of the user system 102 (e.g., “selfies”), which may then be augmented with augmentation data (e.g., filters) described above. The rear cameras may, for example, be used to capture still images and videos in a more traditional camera mode, with these images similarly being augmented with augmentation data. In addition to front and rear cameras, the user system 102 may also include a 360° camera for capturing 360° photographs and videos.

Further, the camera system of the user system 102 may include dual rear cameras (e.g., a primary camera as well as a depth-sensing camera), or even triple, quad or penta rear camera configurations on the front and rear sides of the user system 102. These multiple cameras systems may include a wide camera, an ultra-wide camera, a telephoto camera, a macro camera, and a depth sensor, for example.

The position components 834 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 808 further include communication components 836 operable to couple the machine 800 to a network 838 or devices 840 via respective coupling or connections. For example, the communication components 836 may include a network interface component or another suitable device to interface with the network 838. In further examples, the communication components 836 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 840 may be another machine or any of a wide variety of peripheral devices (e.g., a peripheral device coupled via a USB).

Moreover, the communication components 836 may detect identifiers or include components operable to detect identifiers. For example, the communication components 836 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph™, MaxiCode, PDF417, Ultra Code, UCC RSS-2D bar code, and other optical codes), or acoustic detection components (e.g., microphones to identify tagged audio signals). In addition, a variety of information may be derived via the communication components 836, such as location via Internet Protocol (IP) geolocation, location via Wi-Fi® signal triangulation, location via detecting an NFC beacon signal that may indicate a particular location, and so forth.

The various memories (e.g., main memory 816, static memory 818, and memory of the processors 804) and storage unit 820 may store one or more sets of instructions and data structures (e.g., software) embodying or used by any one or more of the methodologies or functions described herein. These instructions (e.g., the instructions 802), when executed by processors 804, cause various operations to implement the disclosed examples.

The instructions 802 may be transmitted or received over the network 838, using a transmission medium, via a network interface device (e.g., a network interface component included in the communication components 836) and using any one of several well-known transfer protocols (e.g., hypertext transfer protocol (HTTP)). Similarly, the instructions 802 may be transmitted or received using a transmission medium via a coupling (e.g., a peer-to-peer coupling) to the devices 840.

### Software Architecture

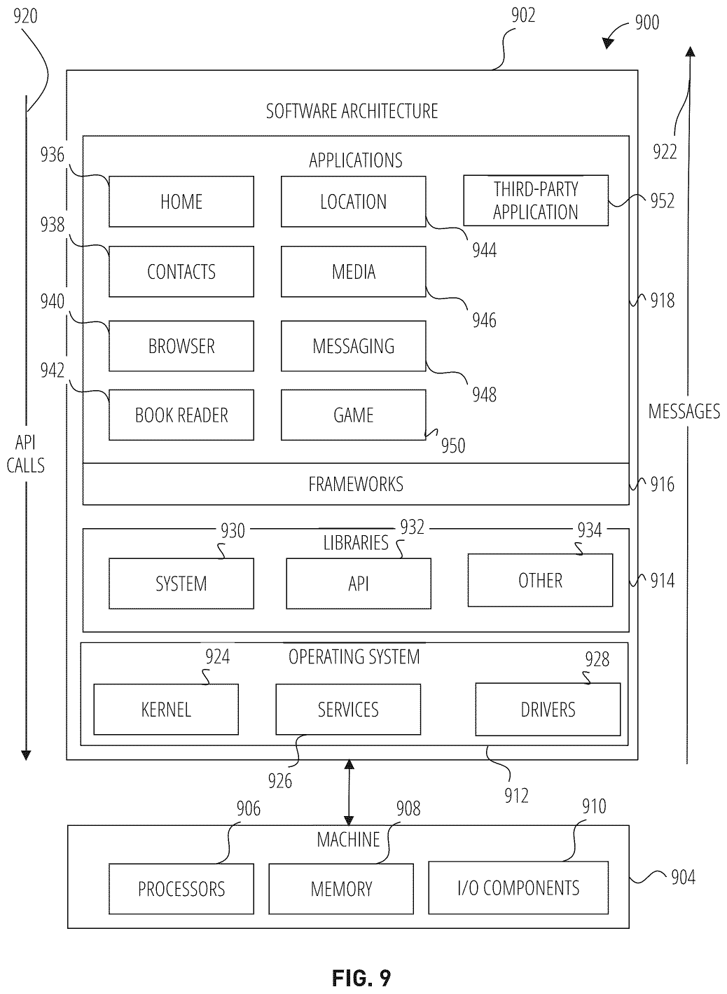

FIG. 9 is a block diagram 900 illustrating a software architecture 902, which can be installed on any one or more of the devices described herein. The software architecture 902 is supported by hardware such as a machine 904 that includes processors 906, memory 908, and I/O components 910. In this example, the software architecture 902 can be conceptualized as a stack of layers, where each layer provides a particular functionality. The software architecture 902 includes layers such as an operating system 912, libraries 914, frameworks 916, and applications 918. Operationally, the applications 918 invoke API calls 920 through the software stack and receive messages 922 in response to the API calls 920.

The operating system 912 manages hardware resources and provides common services. The operating system 912 includes, for example, a kernel 924, services 926, and drivers 928. The kernel 924 acts as an abstraction layer between the hardware and the other software layers. For example, the kernel 924 provides memory management, processor management (e.g., scheduling), component management, networking, and security settings, among other functionalities. The services 926 can provide other common services for the other software layers. The drivers 928 are responsible for controlling or interfacing with the underlying hardware. For instance, the drivers 928 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 914 provide a common low-level infrastructure used by the applications 918. The libraries 914 can include system libraries 930 (e.g., C standard library) that provide functions such as memory allocation functions, string manipulation functions, mathematic functions, and the like. In addition, the libraries 914 can include API libraries 932 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 914 can also include a wide variety of other libraries 934 to provide many other APIs to the applications 918.

The frameworks 916 provide a common high-level infrastructure that is used by the applications 918. For example, the frameworks 916 provide various graphical user interface (GUI) functions, high-level resource management, and high-level location services. The frameworks 916 can provide a broad spectrum of other APIs that can be used by the applications 918, some of which may be specific to a particular operating system or platform.

In an example, the applications 918 may include a home application 936, a contacts application 938, a browser application 940, a book reader application 942, a location application 944, a media application 946, a messaging application 948, a game application 950, and a broad assortment of other applications such as a third-party application 952. The applications 918 are programs that execute functions defined in the programs. Various programming languages can be employed to create one or more of the applications 918, structured in a variety of manners, such as object-oriented programming languages (e.g., Objective-C, Java, or C++) or procedural programming languages (e.g., C or assembly language). In a specific example, the third-party application 952 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 952 can invoke the API calls 920 provided by the operating system 912 to facilitate functionalities described herein.

What is claimed is:

1. A system comprising:
one or more processors; and
a memory storing instructions that, when executed by the one or more processors, cause the one or more processors to:
retrieve, from a data store, a plurality of host actions associated with a plurality of listings of a listing network platform;
derive, via at least one impact assessment model, an importance score for one or more host actions of the plurality of host actions, wherein the importance score is based on a forecasted impact of the one or more host actions on a listing of the plurality of listings;
estimate, via a conversion probability model, a conversion probability for each of the one or more host actions, wherein the conversion probability represents a likelihood that a host of the listing network platform will implement a respective host action of the one or more host actions;
aggregate the importance score and the conversion probability for each of the one or more host actions to generate a final host action ranking score; and
provide the one or more host actions as a recommendation based on the final host action ranking score of each of the one or more host actions.

2. The system of claim 1, wherein the instructions further cause the one or more processors to derive the importance score using a scalable importance function included in the impact assessment model.

3. The system of claim 2, wherein the scalable importance function comprises
$$Δ {v}_{a , l} = {\sum }_{n}^{H} {e}_{n , a , l} \cdot {Lift}_{n , a , l} \cdot Baseline {Outcome}_{n , l} \cdot {C}_{n , a , l}$$
where Δv_{a,l} is an expected increase in importance from taking the respective host action, Lift_{n,a,l} is a forecast lift from taking the respective host action, Baseline Outcome_{n,l} is a baseline outcome of interest, and C_{n,a,l} is a probability that the respective host action will be followed.

4. The system of claim 3, wherein the forecast lift comprises is expected increase in the baseline outcome of interest as a result of following the respective host action.

5. The system of claim 1, wherein the instructions further cause the one or more processors to determine an eligibility status for each host action and to derive an eligible host action only if the eligibility status is an eligible status.

6. The system of claim 5, wherein the eligibility status is indicative of a listing's qualification to implement the respective host action.

7. The system of claim 5, wherein the instructions further cause the one or more processors to apply a guardrailing rule to a respective listing for the eligible host action, and to derive the importance score for the eligible host action only if the guardrailing rule passes the respective listing.

8. The system of claim 7, wherein the guardrailing rule comprises a regulatory rule, a host behavior rule, or a combination thereof.

9. The system of claim 1, wherein the instructions further cause the one or more processors to create a ranked list of two or more host actions of the one or more host actions based on the final host action ranking score of each of the two or more host actions, and to provide the ranked list as the recommendation.

10. The system of claim 1, wherein the instructions further cause the one or more processors to present a graphical user interface (GUI) comprising a dashboard, and wherein the dashboard is configured to display one or more revenue opportunities based on the one or more host actions.

11. The system of claim 10, wherein the instructions further cause the one or more processors to display a chart derived from the one or more host actions inside of the dashboard.

12. The system of claim 1, wherein the impact assessment model further comprises an amenities model configured to infer an importance of an amenity as the impact score based on a frequency of guest inquiry and a complaint contained within an unstructured text, an Availability Retention Reactivations (AARR) model configured to model how supply and demand inputs match and produce a number of nights reserved via a Cobb-Douglas matching function as the impact score, a merchandising model configured to use a propensity score matching (PSM) to derive the impact score, a pricing model configured to model price elasticity as the impact score, or a combination thereof.

13. A method, comprising:
retrieving, from a data store, a plurality of host actions associated with a plurality of listings of a listing network platform;
deriving, via at least one impact assessment model, an importance score for one or more host actions of the plurality of host actions, wherein the importance score is based on a forecasted impact of the one or more host actions on a listing of the plurality of listings;
estimating, via a conversion probability model, a conversion probability for each of the one or more host actions, wherein the conversion probability represents a likelihood that a host of the listing network platform will implement a respective host action of the one or more host actions;
aggregating the importance score and the conversion probability for each of the one or more host actions to generate a final host action ranking score; and
providing the one or more host actions as a recommendation based on the final host action ranking score of each of the one or more host actions.

14. The method of claim 13, further comprising deriving the importance score using a scalable importance function included in the impact assessment model.

15. The method of claim 14, wherein the scalable importance function comprises
$$Δ {v}_{a , l} = {\sum }_{n}^{H} {e}_{n , a , l} \cdot {Lift}_{n , a , l} \cdot Baseline {Outcome}_{n , l} \cdot {C}_{n , a , l}$$
where Δv_{a,l} is an expected increase in importance from taking the respective host action, Lift_{n,a,l} is a forecast lift from taking the respective host action, Baseline Outcome_{n,l} is a baseline outcome of interest, and C_{n,a,l} is a probability that the respective host action will be followed.

16. The method of claim 13, wherein the impact assessment model further comprises an amenities model configured to infer an importance of an amenity as the impact score based on a frequency of guest inquiry and a complaint contained within an unstructured text, an Availability Retention Reactivations (AARR) model configured to model how supply and demand inputs match and produce a number of nights reserved via a Cobb-Douglas matching function as the impact score, a merchandising model configured to use a propensity score matching (PSM) to derive the impact score, a pricing model configured to model price elasticity as the impact score, or a combination thereof.

17. A non-transitory machine-readable medium storing instructions that, when executed by a computer system, cause the computer system to perform operations comprising:
retrieving, from a data store, a plurality of host actions associated with a plurality of listings of a listing network platform;
deriving, via at least one impact assessment model, an importance score for one or more host actions of the plurality of host actions, wherein the importance score is based on a forecasted impact of the one or more host actions on a listing of the plurality of listings;
estimating, via a conversion probability model, a conversion probability for each of the one or more host actions, wherein the conversion probability represents a likelihood that a host of the listing network platform will implement a respective host action of the one or more host actions;
aggregating the importance score and the conversion probability for each of the one or more host actions to generate a final host action ranking score; and
providing the one or more host actions as a recommendation based on the final host action ranking score of each of the one or more host actions.
further comprising deriving the importance score using a scalable importance function included in the impact assessment model.

18. The non-transitory machine-readable medium of claim 17, wherein the operations further comprise deriving the importance score using a scalable importance function included in the impact assessment model.

19. The non-transitory machine-readable medium of claim 18, wherein the scalable importance function comprises
$$Δ {v}_{a , l} = {\sum }_{n}^{H} {e}_{n , a , l} \cdot {Lift}_{n , a , l} \cdot Baseline {Outcome}_{n , l} \cdot {C}_{n , a , l}$$
where ΔV_{a,l} is an expected increase in importance from taking the respective host action, Lift_{n,a,l} is a forecast lift from taking the respective host action, Baseline Outcome_{n,l} is a baseline outcome of interest, and C_{n,a,l} is a probability that the respective host action will be followed.

20. The non-transitory machine-readable medium of claim 17, wherein the impact assessment model further comprises an amenities model configured to infer an importance of an amenity as the impact score based on a frequency of guest inquiry and a complaint contained within an unstructured text, an Availability Retention Reactivations (AARR) model configured to model how supply and demand inputs match and produce a number of nights reserved via a Cobb-Douglas matching function as the impact score, a merchandising model configured to use a propensity score matching (PSM) to derive the impact score, a pricing model configured to model price elasticity as the impact score, or a combination thereof.
